(19) United States
(12) Patent Application Publication
(10) Pub. No.: US 2013/0044696 A1
(43) Pub. Date: Feb. 21, 2013

(54) CIRCUIT SWITCHED FALL BACK WITHOUT CONNECTION RELEASE AUTHORIZATION

(71) Applicants: Vipul DALAL, San Diego, CA (US); Amit Kalhan, San Diego, CA (US); Arockia Sunder, San Diego, CA (US); Tariq Hassan, San Jose, CA (US)

(72) Inventors: Vipul DALAL, San Diego, CA (US); Amit Kalhan, San Diego, CA (US); Arockia Sunder, San Diego, CA (US); Tariq Hassan, San Jose, CA (US)

(21) Appl. No.: 13/212,945

(22) Filed: Aug. 18, 2011

(51) Int. Cl. H04W 4/00; H04W 72/04

(52) U.S. Cl. 370/329; 370/328

(57) ABSTRACT

A mobile wireless communication device, in response to a circuit switched page message, suspends an LTE session and engages in a circuit switched call without a determination of receipt of a connection release message from the LTE network. The mobile wireless communication device, therefore, suspends the LTE session before, or without, receiving any connection release message authorizing the termination of the LTE session.

### FIELD

This invention generally relates to wireless communications and more particularly to circuit switched fall back (CSFB).

### BACKGROUND

The evolution of wireless communication technologies often requires that newer systems and networks be compatible with legacy systems and networks. A communication specification defining operation of new technology often provides requirements for the new system to interface with the legacy systems. For example, the 3GPP Long term Evolution (LIE) standard requires that a wireless communication device be able to use circuit switched networks for voice calls as well as utilize the LTE network. One aspect of the 3GPP LTE specification, referred to as Circuit Switched Fallback (CSFB), requires that a mobile wireless communication device be able to receive incoming calls from the circuit switched network, temporarily suspend any LTE session, engage in the circuit switched call, and return to the LTE network after the circuit switched network call is complete. Unfortunately, the specifications defining the operation of the different networks are often in conflict in certain circumstances.

### SUMMARY

A mobile wireless communication device, in response to a circuit switched page message, suspends an LTE session and engages in a circuit switched call without a determination of receipt of a connection release message from the LTE network. The mobile wireless communication device, therefore, suspends the LTE session before, or without, receiving any connection release message authorizing the suspension of the LTE session.

### BRIEF DESCRIPTION OF THE DRAWINGS

FIG. 1 is a block diagram of a mobile wireless communication device interfacing with a circuit switched network and a LTE network.

FIG. 2 is a message diagram of the message transmissions with the wireless communication device.

FIG. 3 is a message diagram of message transmissions with the wireless communication device where an LTE suspension indicator indicating that the LTE session will be suspended is transmitted to LTE network.

FIG. 4 is a flow chart of a method of circuit switched fall back performed at a mobile wireless communication device.

### DETAILED DESCRIPTION

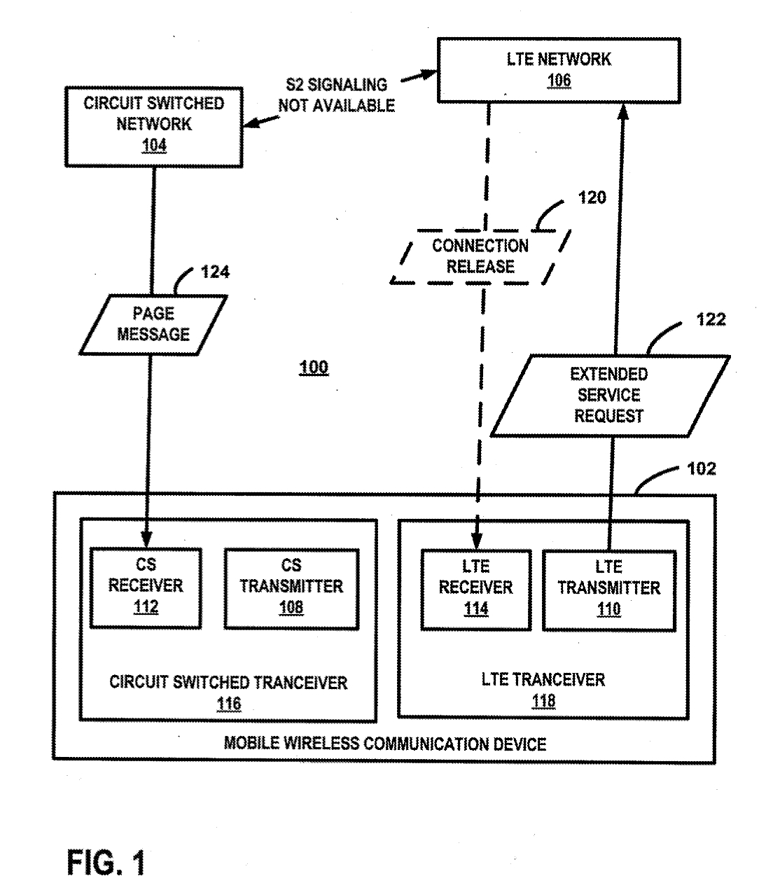

FIG. 1 is a block diagram of a mobile wireless communication device (MWCD) 102 interfacing with a circuit switched network 104 and a 3GPP Long term Evolution (LTE) network (LTE network) 106. The functions and operations of the blocks described in FIG. 1 may be implemented in any number of devices, circuits, or elements. Two or more of the functional blocks may be integrated in a single device and the functions described as performed in any single block may be implemented over several devices. In addition, elements or devices used for a particular function may also be part of other blocks that perform other functions. For example, some electronics that are part of a receiver may also form a portion of a transceiver. Therefore, a function described as performed by a particular device, node, or entity may be at least partially performed by at least one other device, node, or entity in some situations.

The circuit switched network 104 and the LTE network 106 provide communication services to wireless devices within a common geographical region although each network 104, 106 may provide services in some areas that the other cannot. Each network 104, 106 includes infrastructure such as base stations, communication management equipment, and backhaul. The circuit switched network 104 is any wireless communication network where a physical communication path is dedicated to communication with the mobile wireless communication device 102. For the examples herein, the circuit switched network 104 is a network that operates in accordance with 1x CDMA standards.

The LTE network 106 is a packet switched network where a physical path is shared between multiple communication devices. The information related to communication with a particular mobile wireless communication device is arranged into packets and interlaced with packets corresponding to communications with other mobile wireless communication devices.

As is known, in some circumstances, LTE networks may communicate with circuit switched networks allowing call management and other information to be exchanged between the networks. S2 signaling is often used in these circumstances. In this example, however, there is no S2 signaling capability between the LTE network 106 and the circuit switched network 104. Accordingly, the LTE network 106 cannot communicate, either temporarily or permanently, with the circuit switched network 104 using S2 signaling.

The mobile communication device 102 is capable of communicating with a circuit switched network 104 and with an LTE network 106 but does not simultaneously transmit signals to both networks 104, 106. The mobile wireless communication device 102 includes a circuit switched transmitter 108, an LTE transmitter 110, a circuit switched receiver 112, and a LTE receiver 114. The mobile wireless communication device 102, therefore, includes a circuit switched transceiver 116 and an LTE transceiver 118, where the circuit switched transceiver 116 includes the circuit switched transmitter 108 and the circuit switched receiver 112 and where the LTE transceiver 118 includes the LTE receiver 114 and the LTE transmitter 110. Although the receivers and transmitters are illustrated as separate blocks, the functions of these components may be implemented with common circuitry and devices. The LTE transmitter 110 transmits signals that are to be received by one or more base stations within the LTE network 106. The circuit switched transmitter 108 is configured to transmit signals in accordance with the circuit switched network protocol to be received by one or more base stations in the circuit switched network 104. In the examples discussed herein, the transmitters 108, 110 cannot transmit simultaneously. This may be due to any of several circumstances such as, for example, the transmitters sharing common elements or circuitry that does not allow simultaneous functionality of both transmitters 108, 110. In some situations, the transmitters 108, 110 cannot be used at the same time because transmission, spurious, and/or harmonic signals due to one of the transmitters may cause interference with transmission of the other transmitter. The receivers 112, 114 are configured such that the circuit switched receiver 112 is capable of receiving at least some messages from the circuit switched network 104 when the mobile wireless communication device 102 is communicating with the LTE network 106. The receivers 112, 114 may be able to simultaneously receive signals from the two networks 104, 106 in some circumstances. The circuit switched receiver 112, however, is at least capable of intermittently receiving signals from the circuit switched network 104 while the mobile wireless communication device 102 is receiving LTE signals during an LTE session. As a result, the mobile wireless communication device 102 can receive signals from the circuit switched network 104 while maintaining a communication session with the LTE network 106 but cannot transmit to the circuit switched network 104 while maintaining the LTE communication session. The mobile wireless communication device 102, therefore, cannot simultaneously maintain a voice call on the circuit switched network 104 and maintain a session on the LTE network 106.

As described above, the Circuit Switched Fallback (CSFB) of the 3GPP LTE specification requires that a mobile wireless communication device 102 be able to receive incoming calls from the circuit switched network 104, temporarily suspend any LTE session, engage in the circuit switched call, and return to the LTE network 106 after the circuit switched call is complete. Without S2 signaling (or other suitable signaling) between the networks, however, the circuit switched network 104 cannot inform the LTE network 106 of an incoming circuit switched call and that the LTE session should be suspended for a particular mobile wireless communication device. In addition, conventional techniques require that the mobile wireless communication device 102 receive a connection release message 120, such as a radio resource control (RRC) Connection Release Message before suspending the LTE session. In conventional systems, the mobile wireless communication device 102 sends an extended service request 122, such as an Extended Service Request message, to the LTE network 106 prior to responding to a call page (page message) 124 from a circuit switched network 104. The LTE network 106 generates the connection release message 120 authorizing the suspension of the LTE session. With the timing requirements of conventional protocols, the connection release message 120 may not be received before the mobile wireless communication device must respond to the page message 124 sent from the circuit switched network 104. In accordance with the examples discussed herein, however, the mobile wireless communication device 102 suspends the LTE session before, or without ever, receiving a connection release message 120 authorizing release of the LTE session.

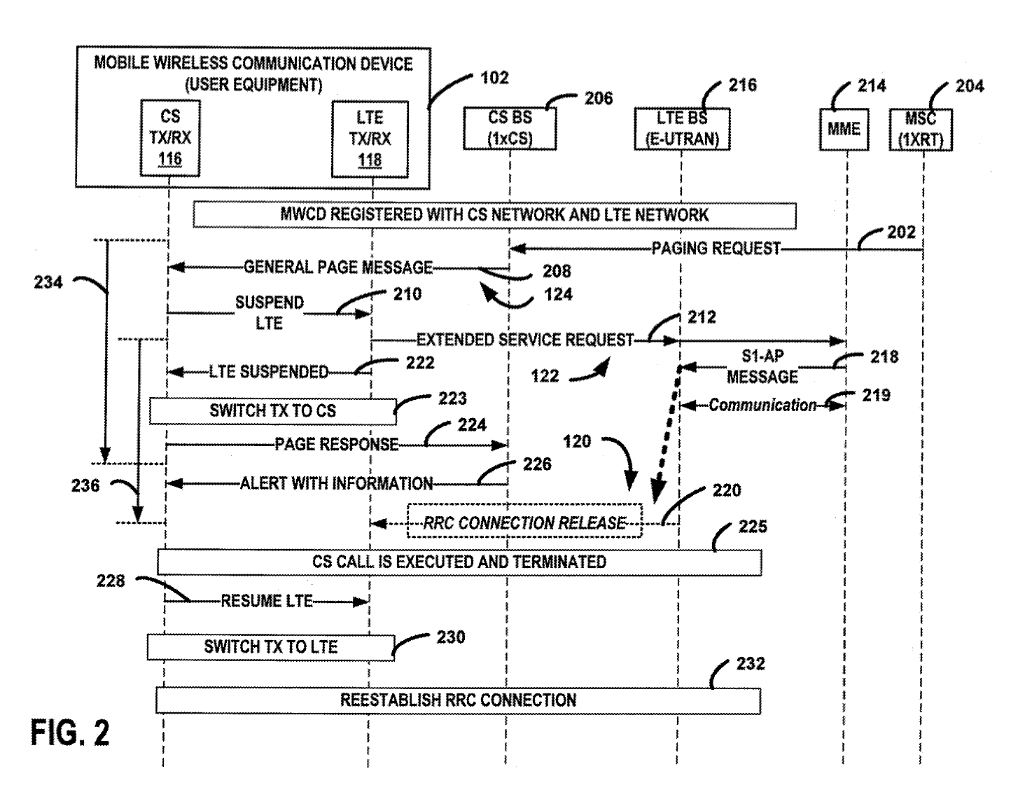

FIG. 2 is a messaging diagram of the communications of the mobile wireless communication device 102 with the LTE network 106 and the circuit switched network 104. The mobile wireless communication device 102 is registered with both networks for this example and begins with the LTE transmitter 110 in an idle mode or transmitting mode. In accordance with LTE operation, a mobile wireless communication device that is registered on the LTE network must be prepared to transmit to the LTE network even if the mobile wireless communication device is not engaged in an active LTE session. Since the mobile wireless communication device 102 is not capable of transmitting to the LTE network 106 when answering the call page, the mobile wireless communication device 102 must inform the LTE network 106 that mobile wireless communication device 102 is no longer available for LTE communication.

A Paging Request message 202 is generated by a mobile switching center (MSC) 204 in the circuit switched network 104. The Paging Request message 202 is forwarded to the circuit switched base station 206 in the circuit switched network 104 invoking transmission of a corresponding General Page message 208 from the circuit switched base station 206 to the mobile wireless communication device 102 in accordance with known techniques. The General Page message 208 is, therefore, an example of a call page message 124 described above with reference to FIG. 1. The circuit switched receiver 112 in the circuit switched transceiver 116 receives the General Page message 208 (page message 124).

In response to the General Page message 208 (page message 124), the mobile wireless communication device 102 determines whether the LTE session should be temporarily suspended. In accordance with known techniques, the mobile wireless communication device 102 evaluates the status of communications to determine, for example, whether the mobile wireless communication device 102 is connected to the LTE network. As described herein, the mobile wireless communication device 102 is determined to be connected to the LTE network 106 if it is registered on the LTE network 106 and is either in the LTE idle state or in the LTE transmission state. If it is determined that the LTE session should be temporarily suspended, appropriate instructions are provided to the LTE transceiver 118 to facilitate notification to the LTE network 106. The LTE network 106 is notified even if the mobile wireless communication device 102 is in the LTE idle state so that the LTE network 106 does not continue to expect responses of acknowledgments when the mobile wireless communication device 102 has suspended LTE communication and will temporarily not be transmitting LTE messages. For example, when in the idle state, the mobile wireless communication device 102 may still need to send messages such as LTE page responses. The suspend LTE instruction 210 in FIG. 2 represents the process and exchange of signals and information within the mobile wireless communication device 102 to initiate suspension of LTE transmission.

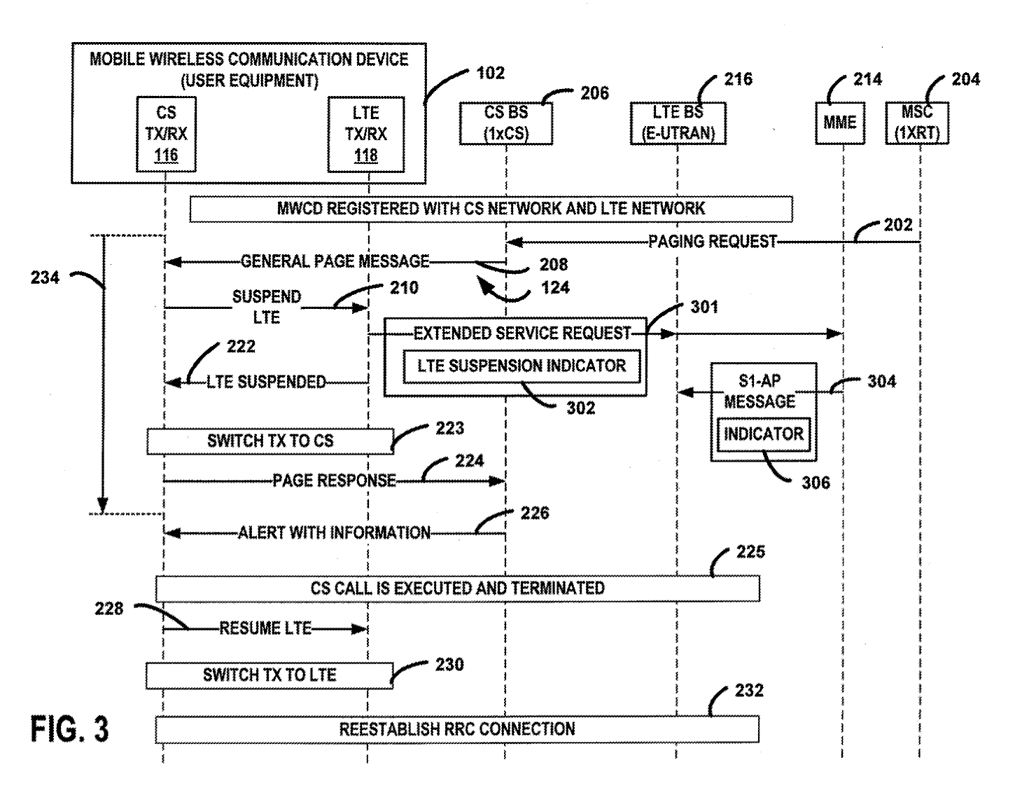

The mobile wireless communication device 102 responds to the paging request 124 by transmitting an Extended Service Request message 212 to a Mobility Management Entity (MME) 214 in the LTE communication network 106 through the LTE base station 216. Therefore, the LTE transmitter 110 in the LTE transceiver 118 transmits the message 212 to the LTE base station 216 which then conveys the message 212 to the MME 214. The Extended Service Request message 212, therefore, is an example of the extended service request 122 discussed with reference to FIG. 1. The communication between the LTE transceiver 118 and the LTE base station 216 conforms to an LTE air interface protocol such as an air interface in accordance with Evolved Universal Terrestrial Radio Access Network (E-UTRAN). As discussed below with reference to FIG. 3, in some circumstances, the Extended Service Request message 212 may include additional indicator and/or an additional field not present in conventional systems.

In response to the Extended Service Request message 212, the MME 214 sends an S1-AP message 218 to the LTE base station 216. The S1-AP message 218 is an application protocol message that instructs the LTE base station 216 to send an RRC Connection Release message 220 to the mobile wireless communication device 102. In the TS 36.413 specification, the S1-AP message 218 is a UE Context Modification Request message that includes a CS Fallback indicator IE informing the LTE base station 216 to send the RRC Connection Release message 220. As described below with reference to FIG. 3, the S1-AP message 218 can be configured to indicate that the RRC Connection Release message 220 need not be sent. For the example of FIG. 2, the S1-AP message 218 is in accordance with conventional techniques and, therefore, the RRC Connection Release message 220 is sent to the mobile wireless communication device 102. Typically there is additional communication 219 between the MME 214 and the LTE base station 216 in between the transmission of the S1-AP message 218 and the transmission of the RRC Connection Release message 220. In the interest of clarity and brevity, these known communications are not discussed herein.

In response to the S1-AP message 218, the LTE base station 216 sends the RRC Connection Release message 220 (connection release 120). The RRC Connection Release message 220 is illustrated with dashed lines to indicate that the message is not considered by the mobile wireless communication device 102 in the embodiments discussed herein and that, in some situations, the message 220 is not sent. The RRC Connection Release message 220 is an example of a connection release message 120 discussed with reference to FIG. 1. In conventional systems, the mobile wireless communication device 102 does not suspend the LTE session until the RRC Connection Release message 220 is received. The RRC Connection Release message 220 is a connection release message 120 that authorizes the mobile wireless communication device 102 to release all LTE radio resources and to temporarily suspend the LTE session. In the exemplary embodiments, however, the mobile wireless communication device 102 does not wait for authorization and suspends LTE communication after the Extended Service Request message 212 is transmitted.

An LTE suspended notification 222 in FIG. 2 indicates that LTE communications have been suspended. The LTE suspended notification 222 in FIG. 2 represents the process and exchange of signals and information within the mobile wireless communication device 102 and does not necessarily represent a transmitted message. In the exemplary embodiment, the LTE transceiver 118 indicates that the Extended Service Request 212 has been sent and the mobile wireless communication device 102 is configured to transmit circuit switched signals. Hardware and code in the mobile wireless communication device 102 are configured to facilitate transmission of circuit switched signals in accordance with known techniques. At event block 223, therefore, the mobile wireless communication device 102 is configured to transmit circuit switched signals.

The circuit switched transmitter 108 in the circuit switched transceiver 116 transmits a page response message 224 to respond to the page message 124 (General Page message 208) in accordance with conventional techniques. The circuit switched base station 206 responds with an alert with information message 226 in accordance with conventional techniques.

At event block 225, the circuit switched call is executed and terminated in accordance with known techniques before the mobile wireless communication device 102 resumes LTE connectivity. The Resume LTE indicator 228 in FIG. 2 represents the process and exchange of signals and information within the mobile wireless communication device 102 to initiate reestablishment of the LTE communication. At event block 230, the mobile wireless communication device 102 is configured to transmit LTE signals. At event block 232, the LTE transmitter transmits messages in accordance with conventional techniques to reestablish the RRC radio connection to sustain LTE communication.

For the example of FIG. 2, therefore, the mobile wireless communication device 102 does not wait for authorization from the LTE network 106 to switch to circuit switched transmission and respond to the page message 124. This avoids the limitations of conventional systems where the RRC Connection Release message 220 may not be received until after the maximum time allowed for responding to the General Page message 208. Accordingly, the RRC Connection Release message 220 is shown in FIG. 2 as occurring after the LTE Network 106 determines that LTE session has been suspended and that authorization has been provided to suspend the LTE session releasing all radio resources. The page response 224 is transmitted before the maximum time allowed for response 234. The time 236 from transmission of the Extended Service Request message 212 to receipt of the RRC Connection Release message 220 could be as long as ten seconds if the system operates in accordance with LTE standards. The page request for the circuit switched call, however, will expire 4.3 seconds from the transmission of the General Page message 208 due to two timers from (T33m and T44m) from the reception of the General Page message to transmission of Page Response. Since these timers are 300 ms and 4 seconds, respectively, the total time is 4.3 seconds. In some situations in conventional systems, therefore, the RRC Connection Release message 220 will not be received in time to allow the mobile wireless communication device 102 to timely respond to the page message 124.

In situations where the RRC Connection Release message 220 is transmitted, the mobile wireless communication device 102 does not respond for the example of FIG. 2. In accordance with the protocol of the LTE network 106, the LTE base station 216 resends the RRC Connection Release message 220 a set number of times without receiving a response from the mobile wireless communication device. The retransmissions are typically executed at lower communication layers such as the physical layer.

Therefore, the example of FIG. 2 does not include modifying the conventional 3GPP messaging. Conventional messages are transmitted by the networks. The mobile wireless communication device 102, however, does not wait for the RRC Connection Release message 220 before suspending LTE transmissions and responding to the General Page message 208.

FIG. 3 is a messaging diagram of the communications of the mobile wireless communication device 102 with the LTE network 106 and the circuit switched network 104 in an example where the Extended Service Request message 301 includes an indicator 302 that notifies the LTE network 106 that the mobile wireless communication device 102 is suspending LTE communications. The indicator 302 may be implemented within one or more fields in the Extended Service Request message 301 that are additional to fields in a conventional Extended Service Request message 212. The indicator 302 includes information that informs the MME 214 that the mobile wireless communication device 102 is tearing down (suspending) the LTE session. The Extended Service Request message 301 is created by the mobile wireless communication device 102 and indicates that the mobile device is entering “mobile originating CS fallback or 1 xCS fallback” or “mobile originating CS fallback emergency call or 1xCS fallback emergency call” as defined by the LTE standards. For the example of FIG. 3, the Extended Service Request 122 also includes the indicator 302 either in a currently defined field or within an additional field within the Extended Service Request message 301. The indicator 302 indicates that the mobile wireless communication device 102 will not wait for the response to the Extended Service Request 122.

The LTE base station 216 forwards this Extended Service Request 301 with the LTE suspension indicator 302 to the MME 214. The LTE base station 216 does not parse this message and only passes it on to the MME 214. In response to this indicator 302, the MME 214 sends a S1-AP message 304 that indicates that the LTE base station 216 need not send a connection release message 120, such as an RRC Connection Release message 220, for example. The S1-AP message 304, therefore, includes an indicator 306 that may be implemented within a currently defined field or within an additional field within the S1-AP message. The indicator 302 provides information indicating the mobile wireless communication device 102 will not wait for a connection release message and/or that a connection release message should not be sent.

The LTE base station 216, therefore, does not send a connection release message 120 such as a RRC Connection Release message 220 in the example of FIG. 3. Communication continues as described above.

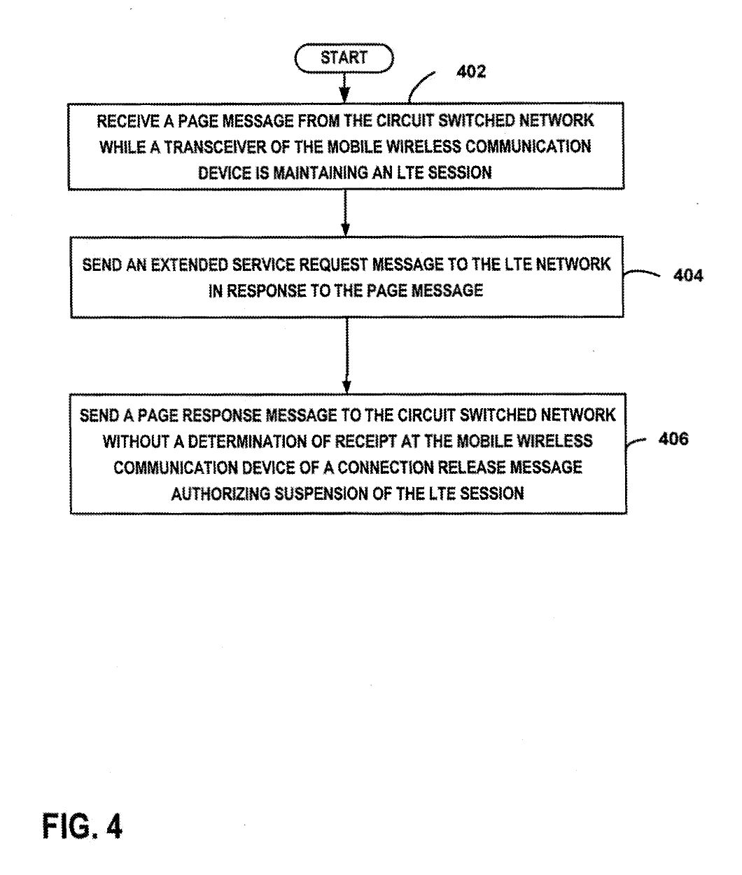

FIG. 4 is a flow chart of a method performed in a mobile wireless communication device 102 configured to non-simultaneously maintain a circuit switched call with a circuit switched network and a Long Term Evolution (LTE) session with an LTE network. The method may be executed using any combination of hardware and/or code within a mobile wireless communication device 102.

At step 402, a page message 124 is received from the circuit switched network 104 while the LTE transceiver 118 is maintaining an LTE session with the LTE network 106. The mobile wireless communication device 102 is engaged in the LTE session when the page message 124 is received through the circuit switched receiver 112 of the circuit switched transceiver 116.

At step 404, an extended service request 122 such as Extended Service Request message 212, is sent to the LTE network 106. In response to the page message 124, the circuit switched functions of the mobile wireless communication device 102 internally inform the LTE functions of the wireless communication device 102 that LTE session should be suspended. As discussed above, this notification can be described as a suspend LTE notification 210 sent internally from the circuit switched functions to the LTE functions although an actual defined message may not be sent. In response, the LTE transmitter 110 sends the Extended Service Request message 212 to the LTE base station 216 in the LTE network 106.

At step 406, a page response message 224 is sent to the circuit switched network 104. As contrasted to conventional techniques, the mobile wireless communication device 102 does not wait for a connection release 120, such as an RCC Connection Release message 220, before sending the page response 224. The Connection Release message 220 authorizes suspension of the LTE session. For the examples herein, however, the mobile wireless communication device 102 does not wait for a determination that a Connection Release message 220 was received before suspending the LTE session and transmitting the page response message 224. In some situations, the Connection Release message 220 may be received after the page response message 224 is transmitted. In other situations, a Connection Release message 220 may not be sent by the LTE network 106. For example, in one example, the Extended Service Request message 301 includes an LTE suspension indicator 302 indicating that the mobile wireless communication device 102 will not wait for a connection release 120 before suspending the LTE session. The LTE network 106 can be configured to not send an RRC Connection Release message 220 in these circumstances.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A mobile wireless communication device comprising:
a transceiver configured to non-simultaneously maintain a circuit switched call with a circuit switched network and a Long Term Evolution (LTE) session with an LTE network, the transceiver comprising:
a circuit switched receiver configured to receive a page message from the circuit switched network while the transceiver is maintaining an LTE session;
an LTE transmitter configured to send an Extended Service Request message to the LTE network in response to the page message; and
a circuit switched transmitter configured to send a page response message to the circuit switched network without a determination of receipt, at the mobile wireless communication device, of a connection release message authorizing suspension of the LTE session.

2. The mobile wireless communication device of claim 1, wherein the connection release message is received at the mobile wireless communication device after the circuit switched transmitter sends the page response message.

3. The mobile wireless communication device of claim 1, wherein the connection release message is a radio resource control (RRC) Connection Release Message in accordance with LTE standards.

4. The mobile wireless communication device of claim 1, wherein the Extended Service Request message comprises a LTE suspension indicator indicating that the LTE session will be suspended independently of any determination that a connection release message has been received at the mobile wireless communication device.

5. A method performed in a mobile wireless communication device configured to non-simultaneously maintain a circuit switched call with a circuit switched network and a Long Term Evolution (LTE) session with an LTE network, the method comprising:
receiving a page message from the circuit switched network while a transceiver of the mobile wireless communication device is maintaining an LTE session;
sending an Extended Service Request message to the LTE network in response to the page message; and
sending a page response message to the circuit switched network without a determination of receipt, at the mobile wireless communication device, of a connection release message authorizing suspension of the LTE session.

6. The method of claim 5, further comprising: receiving the connection release message after the sending of the page response message.

7. The method of claim 5, wherein the connection release message is a radio resource control (RRC) Connection Release Message in accordance with LTE standards.

8. The method of claim 5, wherein the Extended Service Request message comprises a LTE suspension indicator indicating that the LTE session will be suspended independently of any determination that a connection release message has been received at the mobile wireless communication device.
